(19) United States
(12) Patent Application Publication
(10) Pub. No.: US 2011/0118868 A1
(43) Pub. Date: May 19, 2011

(54) METHOD FOR CONTROLLING A SYSTEM

(75) Inventors: Jürgen Herrmann, Rosenheim (DE); Marius Michael Herrmann, Rosenheim (DE)

(73) Assignee: KHS GmbH, Dortmund (DE)

(21) Appl. No.: 13/054,151

(22) PCT Filed: Aug. 13, 2009
(86) PCT No.: PCT/EP2009/005869

§ 371 Date: Jan. 14, 2011

(30) Foreign Application Priority Data
Oct. 21, 2008 (DE) 10 2008 053 765.9

(51) Int. Cl. G06F 7/00

(52) U.S. Cl. 700/214

(57) ABSTRACT

The invention relates to a method for controlling a system (175) configured for automatically handling vessels (176) designed for receiving bulk goods, and comprising a plurality of processing stations for the vessels (176), wherein processing stations are checked for functionality during operation of the system, and wherein processing stations identified as non-functional are defined as error locations for running operations, and are automatically excluded from further operation.

### TECHNICAL SCOPE

The present invention relates to a method for monitoring an installation, an arrangement for monitoring an installation and an installation for automatically handling vessels.

### DESCRIPTION OF THE PRIOR ART

Various machines or installations that are realized for the automatic handling of vessels, such as, for example bottles, are known. It is possible, for example with low staffing costs, to fill vessels, such as, for example, bottles or also to clean the same before the filling process using these types of installations. It is also conceivable to use such machines or installations to check the respective vessels for any damage or contamination that may be present.

### SUMMARY OF THE INVENTION

The invention relates to a method for monitoring an installation, which is configured for the automatic handling of vessels that are realized for accommodating bulk goods and which as a number of treatment stations for the vessels. When carrying out the method, treatment stations are checked for operational reliability during the ongoing operation of the installation, treatment stations identified as non-operationally reliable for the ongoing operation each being defined as error locations and being automatically excluded from further operation. The state of treatment stations and/or vessels can be checked in a user-related and target-controlled manner which means that a treatment station and/or a vessel can be checked in a targeted manner at a suitable moment.

The method can be carried out for an installation that includes treatment stations in which vessels are located during the ongoing operation, for example the method can be carried out for treatment stations that are realized for conveying vessels. In addition, the method can be carried out for treatment stations that are realized for acting upon vessels in the ongoing operation. These are, for example, treatment stations that are realized for cleaning, filling, covering and/or labelling vessels. Treatment stations realized for filling vessels are typically filling stations or filling devices that include valves for the bulk goods to be filled into the vessels.

Corresponding to the method according to the invention, no vessel is automatically supplied for processing to a treatment station defined as an error location during the ongoing operation or continued operation of the installation, such that vessels are prevented from being treated defectively by these treatment stations, be it, for example, vessels insufficiently filled with bulk materials or vessels that have been insufficiently cleaned. This means, in its turn, that it is possible to reduce the rejection of defectively treated vessels during on going operation in a considerable manner.

Within the framework of the invention, a treatment station defined as an error location can be automatically deactived when no vessel is situated therein. If said station is a filling station in this case, the corresponding valve or valves of the filling station can be taken out of operation so that they are no longer able to fill a vessel with bulk goods.

As a further measure, a status report on a treatment station defined as an error location can be prepared. In addition, said treatment station can be serviced at a definable moment, in particular when the operation of the installation has been completed. The status report can include, among other things, information on the defective treatment station detected by way of at least one sensor and can be used correspondingly during the servicing process. This can be, among other things, information on any mechanical and/or electronic faults in the respective treatment stations.

In one variant of the method, in dependence on the type and number of treatment stations defined as error locations, at least one operating parameter of the installation can be modified during the ongoing operation. This can mean, among other things, that a frequency for treating the vessels is suitably adapted, typically is increased, as the at least one operating parameter, for example a speed of the installation, is increased, for example. Consequently, a treatment station, missing as it is out of action, can be compensated for in the installation output so that in spite of the failure of the at least one treatment station, the same number of vessels can be acted upon, for example filled.

When the treatment stations are being checked for operational reliability, it is also possible, after the filling process, to determine a fill level of the bulk goods for a vessel to be filled during the ongoing operation at a treatment station to be checked and to perform a check as to whether the fill level is located within or outside a predetermined tolerance range for said fill level. In this case, on the one hand, a vessel can be separated out if the fill level is outside the tolerance range for the fill level. It is additionally provided that it is ascertained at which treatment station the respective vessel, the fill level of which is outside the tolerance range for the fill level, has been filled, and that said treatment station is defined as an error location and is automatically excluded from further operation. This can also be effected retrospectively if the fill level is not monitored until the vessel has been filled if the vessel has passed through at least one additional treatment station, as it is also possible then to trace the treatment station at which the vessel had been filled.

In one development of the method, it is possible to check treatment stations for operational reliability in a random manner. In general, it is conceivable that during the ongoing operation of the installation, a sequence of treatment steps that are carried out by corresponding treatment stations is repeated cyclically in treatment cycles. For random checking of the treatment stations, it is now proposed to predetermine in a type of sequence plan which treatment stations are to be checked in which of the treatment cycles. This sequence plan for sampling, predetermined in a suitable manner by a user, by way of which the samples of treated treatment stations are to be checked for operational reliability, can be stored in a retrievable manner. During the ongoing operation of the installation, consequently, it is possible to call up in which treatment cycle which treatment stations of the number of treatment stations are to be checked for operational reliability. Through these measures, it is possible to select treatment stations provided for checking in a targeted manner, the respective check also being carried out during a treatment cycle that has also be selected in a targeted manner.

This means, for example, that for checking filling stations in filling cycles that are predetermined in the sequence plan, the vessels to be filled there in each case are removed from filling stations as samples in a targeted manner, also predetermined in the created sequence plan, once they have each been filled, and their respective filling is checked. Operationally identical treatment stations can consequently be checked during different treatment cycles. This is expedient, among other things, if the treatment stations, or for example filling stations, are situated in the direct or at least indirect vicinity. Consequently a collision between vessels that are acted upon in neighbouring treatment stations is avoided when they are removed as samples.

Vessels that are additionally identified as defectively filled independently of the sampling carried out in a targeted manner by way of the sequence plan, because for example, a fill level of the bulk goods filled therein is too high or too low, can be removed in a targeted manner, for example, by means of a function “select reject” independently of the current sampling in a separate step, i.e. for example by means of a separate removal system.

A filling station and consequently a valve that has filled the insufficiently filled vessel can easily be identified as each vessel is provided with a precise allocation to treatment stations that act on the vessel. Taking this allocation into consideration, the valve defectively filling, and consequently the respective filling station, can be defined as an error location and excluded from the ongoing operation.

The invention also relates to an arrangement for monitoring an installation, wherein the installation is configured for the automatic handling of vessels that are realized for accommodating bulk goods and includes a number of treatment stations for the vessels. The arrangement is realized to check treatment stations for operational reliability during the ongoing operation of the installation, and to define treatment stations identified as non-operationally reliable for the ongoing operation as error locations and to exclude them automatically from any further operation.

This arrangement is typically realized to carry out at least one step of the method according to the invention described above.

The arrangement can include, among other things, at least one sensor, which is associated with at least one treatment station and is realized to detect a state of an operating parameter of the respective treatment stations and/or a state of a vessel to be treated at the treatment station. A sensor of this type can also be realized as an additional component of the installation and can interact with the arrangement in a corresponding manner when the method is being carried out.

In addition, the invention also comprises a corresponding installation that is realized for the automatic handling of vessels and has an afore-described arrangement according to the invention.

Said installation is realized in a variant for the automatic handling of vessels that are realized, for example, as bottles. Other vessels or containers that are suitable for accommodating bulk goods can normally also be handled with the installation.

The installation according to the invention is realized to monitor a state of the vessels and consequently to regulate and/or control it. Said installation has, among other things, at least one conveying device for conveying vessels as a treatment station, at least one filling station or filling device with valves for filling the vessels with bulk goods and at least one sensor for checking a state or the operating reliability of at least one treatment station and/or of a state of at least one vessel.

Using the at least one conveying device, the vessels can be conveyed within the installation to different treatment stations of the installation. In addition, for at least one treatment station of the installation additionally at least one conveying device can also be provided such that the vessels can also be conveyed, for example during a filling operation, to the corresponding treatment station of the fill station.

The installation according to the invention in a further development has at least one sensor for checking a respective state of at least one treatment station and/or of one or more vessels. This includes the measure of checking at least one treatment station and/or one vessel for its operational reliability. In this case, it can be ascertained whether the vessel is suitable to be filled with corresponding bulk goods. As an alternative or as an addition, the checking of the respective state of a vessel can also include the measure according to which the contents of or a space surrounded by the vessel is checked. In this case it can be determined up to what degree the vessel is filled with bulk goods and/or whether this vessel could possibly be contaminated. If the diagnosis for a vessel is that it is not suitable for the operation of the installation, a treatment station in which such a vessel is located can be defined as an error location.

In addition, the described installation can include as treatment station at least one charging or filling device for filling the respective vessels with the bulk goods. It can also be provided that the installation has as treatment station at least one cleaning device for cleaning the vessels. Normally, the cleaning of the vessels is carried out before the filling or re-filling of the vessels.

Within the framework of the above-described method according to the invention, there is provided, among other things, a monitoring and consequently controlling and/or regulating of the installation that is realized for the automatic handling of vessels, which are realized for accommodating bulk goods. The method includes a number of method steps, for example test steps for monitoring treatment stations and/or vessels. In this case, individual method steps of the method according to the invention can be preconfigured as branches of a tree structure and can represented logically linked and executed with corresponding activation.

In this case, each branch of the tree structure is formed from algorithms, i.e. from handling instructions. Several algorithms are typically linked together and can be correspondingly realized when running through the corresponding branch. In this case, a handling instruction can be realized as a parameter for implementing a corresponding method step or part step. In a further development, levels of the tree structure, such as for example of a corresponding test tree, can be organized in a hierarchical manner.

In the case of a variant of the method, the tree structure with the branches and levels is provided for a user of the installation to be monitored by means of a display device of a suitable device that interacts with the installation. The display device, in this case, can be used as an interface between a respective user of the installation and the installation, such that the user, by means of the display device, can follow, monitor and, where applicable, also influence the automatic handling of the vessels to be carried out by the installation. Thus it is possible, for example, to define treatment stations that have caused an error during operation as error locations in a targeted and also manual manner and to exclude them in a targeted manner from further operation of the installation. However, this latter can also be effected automatically. The described display device, as a rule, is realized as a display field, for example a screen, by means of which the method steps can be visualized, for example, in the form of represented levels. The display device can additionally be realized for acoustic representation of the method steps and can consequently have a loud speaker.

It is possible for a design of an algorithm, as part of a corresponding branch, i.e. of a corresponding method step, to be dependent on a definable condition. In addition, the algorithms can be divided into categories. In this case, one development provides that each category is characterized by a suitable symbol, a symbol of this type being passed to the algorithms of the category and consequently being transmitted. As an alternative or in addition, one level of the tree structure, as a pointer to algorithms that can be associated with one or more of the respective levels, can be represented by one or more of these types of symbols and represented correspondingly by way of the display device. Normally, the individual levels of the tree structure are represented by the display device. Within one level represented, other levels of the tree structure can be displayed by corresponding symbols, which, for example, are imaged on control objects or display fields.

It is also possible for results of respective method steps and consequently of part tasks to be represented to the user via the display device. In a further development, it can also be provided that, by way of the results, statistics are prepared on at least one operating step of the installation. In addition, this opens up the possibility that by using at least one result of the statistics that have been prepared for the at least one operating step, at least one operating parameter is created for an operation to be carried out in the future or for at least one operating step of the installation. Accordingly, the operating steps to be carried out in the future within the framework of the operation can be adapted with consideration to operating steps that have already been carried out and consequently, for example, can be optimized. This is effected typically by taking into account treatment stations that are defined as error locations and are not used when the operation is continued, i.e. are excluded from the ongoing operation.

In one development, the method is suitable for an installation that is configured for monitoring, cleaning and/or filling bottles with a liquid as bulk goods or liquid product.

Within the framework of the method, inspecting can include controlling, adjusting and/or regulating the respective installation. The automatic handling of the vessels, and in particular of bottles, includes, for example, monitoring the vessels for breakage and/or filling the vessels with bulk goods or a liquid product provided for that purpose. In addition, it can also be provided that when the vessels are being handled they are also cleaned.

Bottles, for example as vessels, can be automatically treated by the installation. Filling of the vessels is generally effected with bulk goods, bulk goods being able to be realized as liquid or as a pourable substance that includes a plurality of particles, for example as granulate or powder.

Over and above this, there can also be provided at least one input module, which usually interacts with the arrangement and makes it possible for the user to input data such as, for example, operating parameters, and which is additionally realized to forward operating parameters input by the user to the respective installation such that via said installation for example at least one operating step and consequently at least one function of the installation can be controlled in a targeted manner or adapted in a direct manner. This is effected, among other things, with consideration to the treatment stations of the installation defined as error locations. The input module can include, among other things, control elements or control buttons, which can be operated by a user of the installation during the operation. A series of checks on treatment stations and/or vessels can also be programmed via the input module. This means that the afore-described sequence plan for sampling can be input via the input module. Defective vessels can be separated out in a targeted manner automatically and/or by operating the input module. A filling station with a valve which has given rise to an error for a vessel, for example by defective filling, can also be defined as an error location manually, among other things, by means of the input module.

The described arrangement according to the invention is realized to carry out all the steps of the method presented according to the invention. In this case, individual steps of said method can also be carried out by individual components. In addition, functions of the arrangement or functions of individual components of the arrangement can be configured as steps of the method.

All the steps of a described method can be carried out using a computer program with program code means if the computer program is run on a computer or a corresponding processing unit, in particular in an arrangement according to the invention.

A computer program product with program code means that are stored on a computer-readable data carrier is realized for carrying out all the steps of a described method, if the computer program is realized on a computer or a corresponding processing unit, in particular in an arrangement according to the invention.

Further advantages and developments of the invention are produced from the description and the annexed drawing.

It is obvious that the above-mentioned features and the features still to be mentioned below can be used not only in the combination specified in each case, but also in other combinations or standing alone without departing from the framework of the present invention.

The invention is represented schematically in the drawings by way of exemplary embodiments and is described below with reference to the drawings, in which, in detail:

### BRIEF DESCRIPTION OF THE DRAWINGS

FIG. 1 shows a schematic representation of a topology of an embodiment of an installation according to the invention,

FIG. 2 shows a schematic representation of a first embodiment of an installation according to the invention,

FIG. 3 shows a schematic representation of a second embodiment of an installation according to the invention,

FIG. 4 shows a schematic representation of a third embodiment of an installation according to the invention,

FIG. 5 shows a schematic representation of an example of a result of a diagnosis, as is represented within the framework of an embodiment of the method according to the invention,

FIG. 6 shows a schematic representation of statistics as an example, as is represented within the framework of an embodiment of the method according to the invention,

FIG. 7 shows first detail statistics of the statistics presented in FIG. 6,

FIG. 8 shows a schematic representation of second detail statistics,

FIG. 9 shows a schematic representation of a representation of faults detected by way of the detail statistics already presented,

FIG. 10 shows a schematic representation of details of a method step to be carried out within the framework of an embodiment of the method according to the invention,

FIG. 11 shows a schematic representation of a summary of a tree structure, as can be provided according to an embodiment of the method according to the invention,

FIG. 12 shows a schematic representation of an example of a sampling mode, which is prepared within the framework of an embodiment of the method according to the invention.

### DETAILED DESCRIPTION

The Figures are described in an interrelated, comprehensive manner and identical references identify identical components.

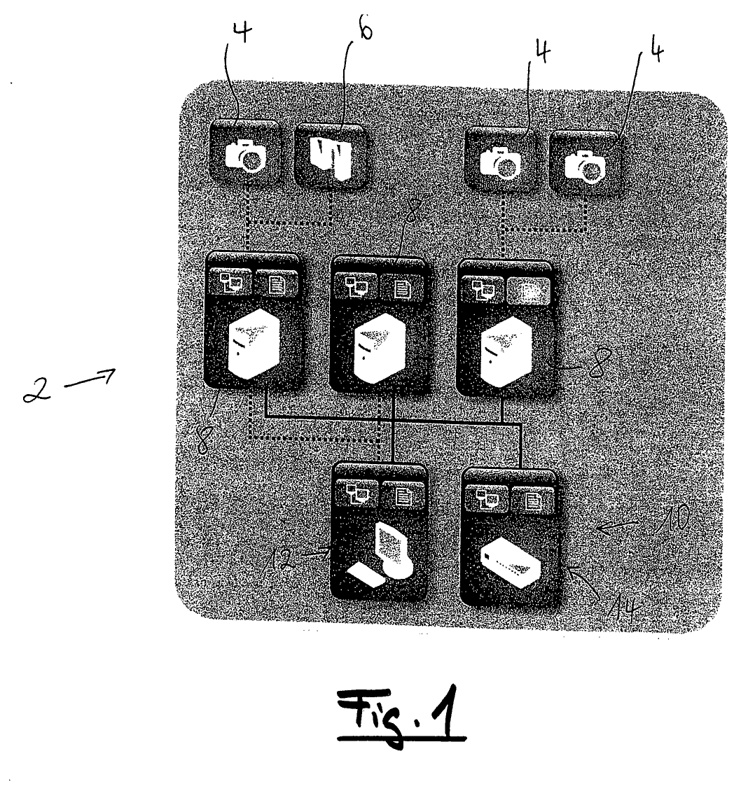

FIG. 1 shows a schematic representation of a topology of an embodiment of an installation 2 according to the invention. The installation 2 includes a plurality of sensors 4 realized as cameras, at least one treatment station realized as an actuator 6 for acting upon vessels, three processing units 8 and one embodiment of a device 10, each of which are marked by means of suitable symbols. Said device 10 includes a display device 12 which is realized as a monitor and a storage device 14 which is realized for processing and storing data that is generated during implementation of the method according to the invention when the installation 2 is operating.

Through the topology of the installation 2, a user or operator and consequently, for example, a service technician for the installation is given a “one look diagnosis” of a corresponding application, which provides the user with an overview of the design of the installation 2 and consequently of a corresponding system. For implementing a variant of the method according to the invention, the user is also given an overview of a state of treatment stations of the installation 2. Consequently, whilst the operation is ongoing, the user can be pointed to defective treatment stations that are defined as error locations.

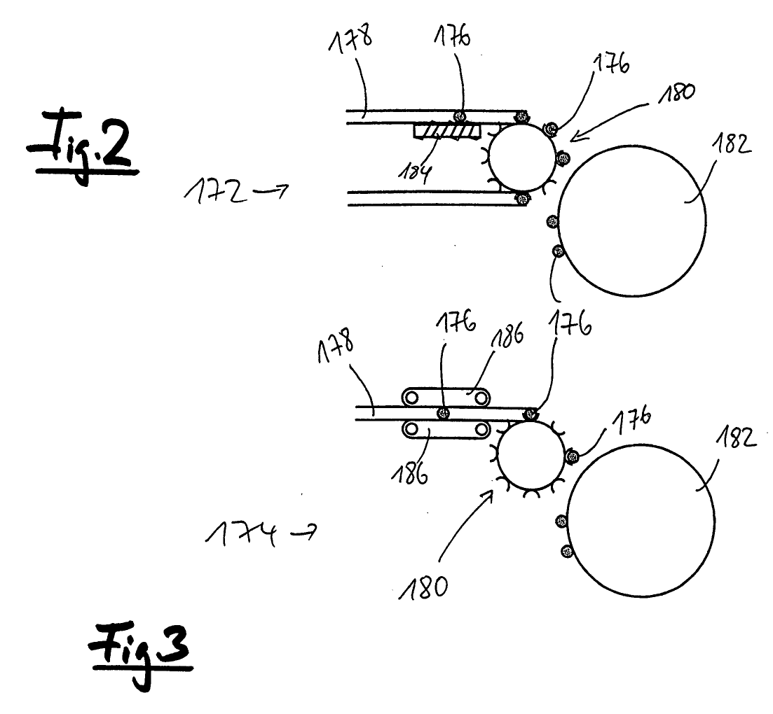

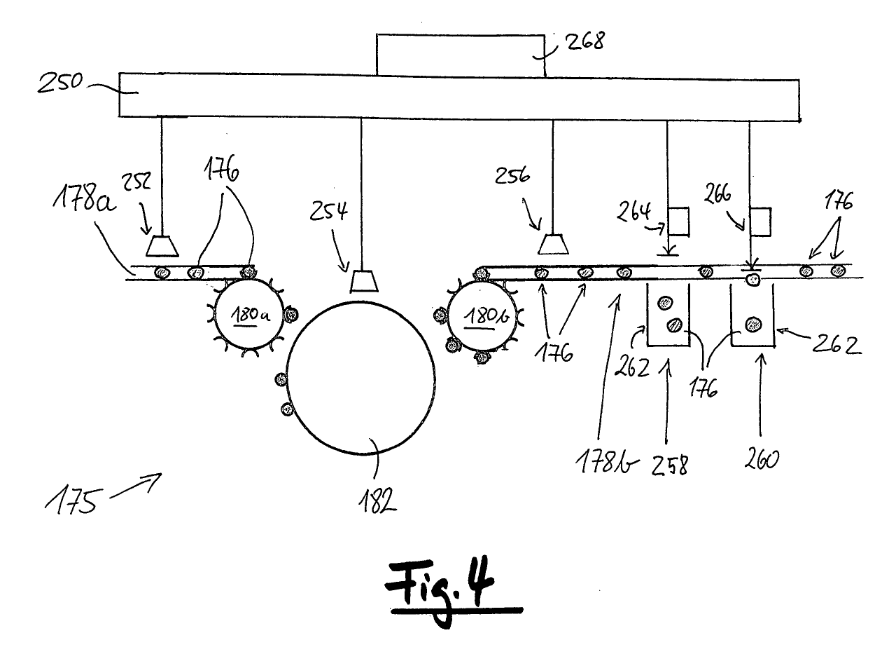

FIGS. 2 and 3 show two embodiments of installations 172, 174 that are configured for automatically handling vessels 176. In this case, both installations 172, 174 include a conveying device 178 as a first treatment station, a second treatment station realized as a clamping star 180 by way of which a circular conveying of the vessels can be carried out, and a filling device 182 as a third treatment station. The two installations 172, 174 differ from each other in detail in the conveying modules of the respective conveying device 178. In this case, a conveying module of the first installation 172 in FIG. 2 is realized as an inlet worm 184.

The conveying module of the second installation 174 in FIG. 3 includes two conveyor belts 186 located parallel to each other, between which a vessel 176 to be conveyed is clamped when being conveyed. By providing the conveyor belts 186, a speed at which the vessels 176 are supplied to the clamping star 180 can be regulated. When the speed is slowed down, vessels 176 are not supplied to all accommodating stations of the clamping star 180 and consequently gaps are created between accommodating stations occupied with vessels 176. By providing these types of gaps, in addition only selected valves of the filling device 182 are occupied with vessels 176. This produces the possibility of excluding valves defined as error locations from the operation, among other things by no vessels 176 being supplied to said valves.

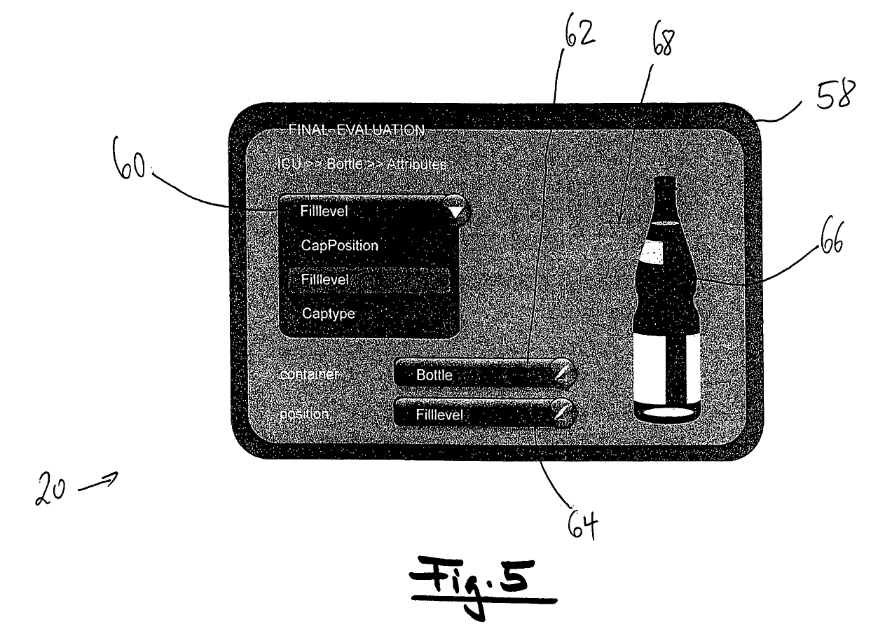

A third embodiment of an installation 175 according to the invention is represented schematically in FIG. 4. Said installation 175 includes as treatment stations a conveying device 178a realized as an inlet, a supplying clamping star 180a, a filling device 182, a discharging clamping star 180b and a conveying device 178b realized as an outlet. During the operation of said installation 175, empty vessels 176 are supplied to the supplying clamping star 180a of the filling device 182 via the conveying device 178a. The treatment station realized as filling device 182 includes a number of additional treatment stations, which include valves for filling the vessels 176. Normally the filling device 182 includes a few dozen, as a rule ca. 100 valves. The vessels 176 filled with bulk goods or filling material in the filling device, once successfully filled, are supplied to the discharging clamping star 180b and in addition to the conveying device 178b realized as the outlet.

In addition, the installation 175 represented in FIG. 4 includes an embodiment of an arrangement 250 according to the invention realized for monitoring said installation 175. Said arrangement 250 includes a first sensor 252 realized as a camera, which is associated with the conveying device realized as an inlet, a second sensor 254 realized as a camera, which is associated with the filling device 182, and a third sensor 256, also realized as a camera, which is associated with the conveying device 178b realized as an outlet. In a development of the method, a state of a respective treatment station, i.e. of the two conveying devices 178a, 178b and of the filling device 182, is determined in a sensory manner by means of the sensors 252, 254, 256 associated with the named treatment stations. In a supplementary manner, states of vessels 176 which are acted upon within the named treatment stations are also detected by the sensors 252, 254, 256. In this case, after successful filling of the vessels 176, a height of a level of the bulk goods to be filled into the vessels 176 is detected at least by means of the third sensor 256 which is associated with the conveying device 178b that is realized as an outlet.

Once the states of treatment stations and/or vessels 176 have been successfully determined, the detected states are checked by the arrangement 250. As a result of this, on the basis of the data on the treatment stations detected by sensors, a decision is made concerning their operational reliability.

With regard to the treatment stations of the filing device 182 realized as valves, a state of the respective valves can be checked in a targeted manner during a treatment cycle. Consequently it is possible to check adjacent valves in different treatment cycles. In the case of the filling device 182, one treatment cycle corresponds to a full cycle, where the filling device 182 is rotated by 360° such that each valve, on completion of a treatment cycle, once again assumes that position within the installation 175 that it assumed at the beginning of the treatment cycle. In particular adjacent valves can consequently be checked at different times, i.e. an n^{th} valve is checked at a 1^{st} treatment cycle and an n+1^{st} valve is checked at an m^{th} treatment cycle. Consequently it is possible to prevent a collision of vessels 176 which are acted upon by adjacent valves and which, after they have been filled, are to be removed for checking the individual valves. In order to increase the operational reliability of the installation 175, an arbitrary number of other valves can be situated between two valves, which are inspected and consequently controlled during treatment cycles that follow directly one after the other. If the result of a check on a valve shows that said valve is defective, this treatment station that includes the valve is defined as an error location and is excluded from the ongoing operation of the installation 175. It is provided for this purpose that no vessel 176 be supplied to the treatment station identified as an error location as the operation continues.

In addition, the installation 175 includes a first removal system 258 and a second removal system 260. In this case each removal system 258, 260 includes a collecting station 262, which is realized for accommodating vessels 176 that have been separated out. The arrangement 250 has associated therewith a first separating out module 264 for the first removal system 258 and a second separating out module 264 of the second removal system 269. Said separating out modules 264, 266 are realized, acted upon by the arrangement 250, to transfer vessels 176 by means of displacement out of the second conveying device 178b into the collecting stations 262.

In this case, vessels 176 are transferred into the collecting station 262 of the first removal system 258, it being ascertained for said vessels during an inspection by the sensor 256 that the height of their fill level is outside a provided tolerance range, meaning that either too much bulk goods or too little bulk goods were filled into such vessels 176.

The second removal system 260 is used for targeted sampling, by way of which a further check on a state of vessels 176 that have already been filled is performed.

By operating a display device 268, it is possible for the user of the installation 175 to monitor the arrangement 250 and to control and/or regulate it accordingly. Consequently the user can select which vessel 176 from which valve or which fill point of the filling device 182 is supplied to the collecting station 262 of the second removal system 260 for further monitoring. It is also possible by operating the display device 268 to select which treatment station of the filling device 182 including a valve is checked at which filling cycle. A selection can be individually generated, stored and called up for this purpose.

Vessels 176 that are not separated out are conveyed via the second conveying device 178b, which is realized as an outlet, for example to another treatment station (not shown) that is realized as a labelling machine and there they are provided with labels.

Separating out vessels 176 can be activated by a control object (“select reject”). This has the effect of selecting and separating out those vessels 176 by the first removal system 258 for which, by way of one of the sensors 254, 256 connected upstream, at the earliest during the filling of a respective vessel 176 and/or after successful filling, the defective fill level is detected for the bulk goods filled in the respective vessel 176. As normally there is an allocation provided as to which vessel is acted upon by which treatment station at which operating cycle, it is also possible to trace back which valve, and consequently by means of which treatment station, the vessel 176 has been defectively filled. The valve responsible for the defective filling is defined as an error location automatically or by activation of the named control object (“select reject”).

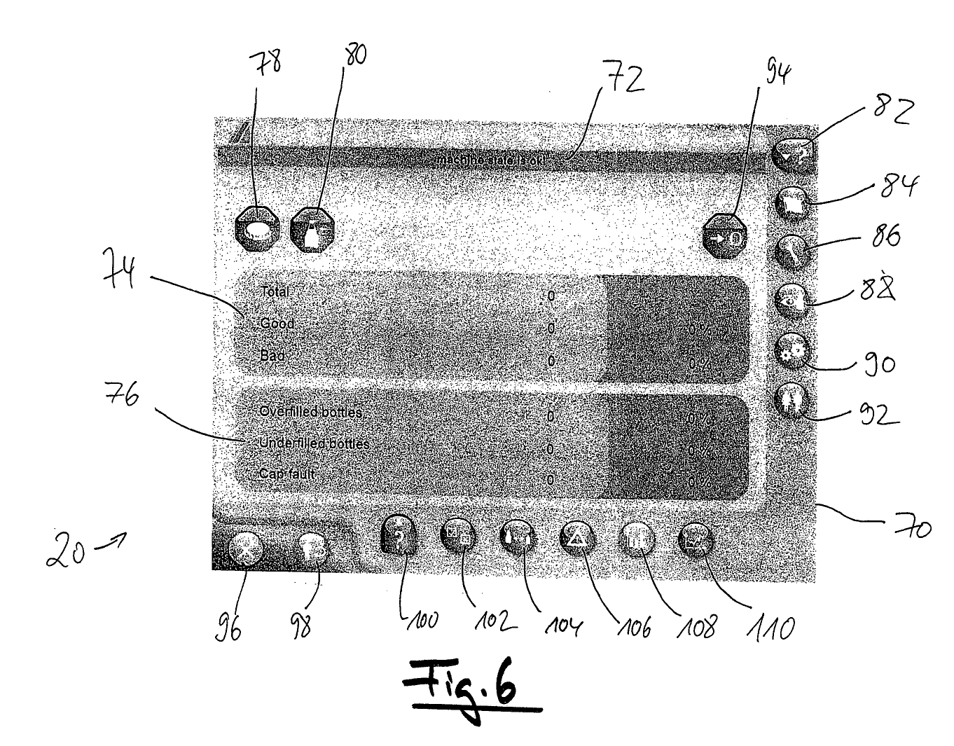

Using the display device 268 that interacts with the arrangement 250 by exchanging data, the user interfaces represented in FIGS. 5 to 12 can be provided for a user of the installation. Consequently, it is possible for the user to monitor a function of the installation 175 by means of the device 268 and correspondingly to control and/or regulate it. An inspection of the installation 175 that can be carried out using the display device 268 also includes, among other things, a check on a state of treatment stations in the installation 175 and/or of vessels 176 that are acted upon by treatment stations of the installation 175.

When implementing the method according to the invention, treatment stations of the filling device 182 that include valves, in so far as said treatment stations are identified as non-operationally reliable, are defined as error locations. Consequently, it is possible to regulate charging or not charging valves with vessels 176. Valves that have been defined as error locations are no longer charged with vessels 176 in the ongoing operation. The error locations are usually repaired once the ongoing operation of the installation 175 has been completed. Consequently, it is not necessary to stop the installation specially to eliminate an error in a treatment station. Depending on how many treatment stations are defined as error locations and are excluded from an ongoing operation, at least one operating parameter of the installation 175 can also be adapted to a number of treatment stations defined as error locations. Consequently it is possible, in spite of the failure of treatment stations, possibly of valves of the filing device 182, to maintain a production target for a number of vessels 176 to be filled by increasing a frequency for treating the vessels, for example, as an operating parameter.

The third sensor 256 is used as a fill level measurement bridge for checking the height of the fill level of the bulk goods inside a filled vessel 176. The sensors 252, 254, 256, realized normally as cameras, can be realized as optical camera systems, high frequency conductance measuring systems, gamma ray measuring bridges and/or x-ray measuring bridges, by means of which the height of the fill level can normally be determined in a precise manner by using electromagnetic waves.

FIG. 5 shows a schematic representation of a result 58 of a diagnosis concerning operating stations and/or vessels or bottles carried out during the method, represented by way of a tree structure 20. In the case of the final evaluation shown here (“final evaluation”), levels of the tree structure, representing the method, for the control device (ICU), for a state of the treatment stations and/or of the bottles (“bottles”) and for the attributes (“attributes”) are run through one after the other. Via a first display element 60 it is possible to select between a representation of a fill level (“filllevel”), a position of a closure (“cap position”) and a closure type (“cap type”). A second display element 62 indicates that in the representation shown here, as an example, the vessels or containers (“containers”) to be treated within the framework of the invention are bottles (“bottles”). A third display element 64 indicates that in this case a fill level (“filllevel”) of a bottle 66 filled with a liquid is selected. As the result 58, in this case, an arrow 68 indicates a fill level for the bottle 66 resulting from an evaluation carried out beforehand, a height of the fill level being conditional on the operational reliability of a treatment station realized for filling the bottle.

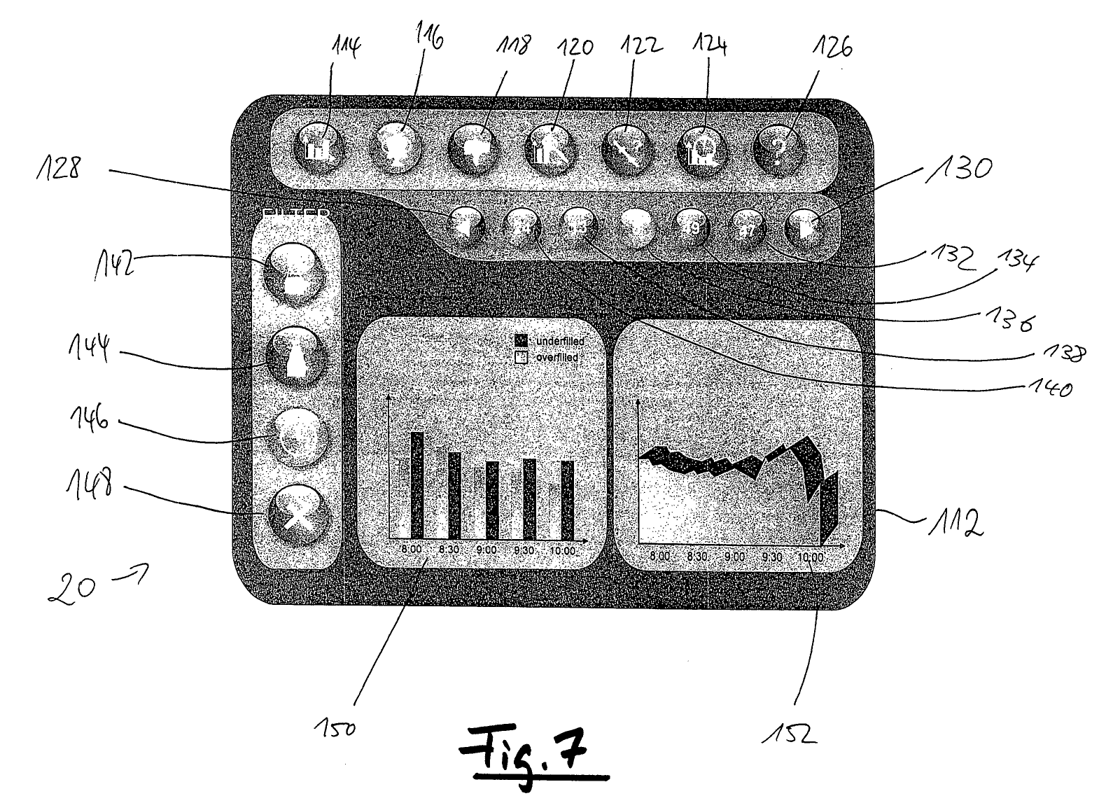

FIG. 6 shows a schematic representation of general statistics 70 in a further level within the tree structure 20. In this case a first display field 72 shows that a current state of the installation, usually at least one treatment station, is classified as “in order” (“machine state is ok!”). A second display field 74 shows a first overview, according to which a total of “zero” vessels have been automatically handled, “zero” vessels having been identified as “good” and “zero” vessels having been objected to as “bad”. A second display field 74 provides information on a number of “overfilled bottles”, “underfilled bottles” and “defective closures”—“cap faults”. If an error should occur during the handling of the vessels, it can be caused by a lack of operational reliability of a treatment station.

In addition, the level on which the general statistics 70 are shown, has further control objects 78, 80, 82, 84, 86, 88, 90, 92, 94, 96, 98, 100, 102, 104, 106, 108, 110 with different symbols. In this case, a picture of a closure appears on the control object 78 which indicates that a state of a closure can be checked and represented via said control object 78. The control object 80 stands for a check on a respective fill level of a bottle. Help can be called up by means of a control object 82. A language for representation and/or input can be selected via a control object 84, which in this case shows a flag. The control object 86, in this case representing a spanner, stands for maintenance or assembly to be carried out on at least one treatment station defined as non-operationally reliable. The control object 88 stands for a visual check on a bottle. The control object 90, on which two intermeshing gear wheels are shown, stands for operating steps to be selected. A control object 92, showing the picture of two people, stands for individual selection of a user. Using the control object 94 it is possible to reset operating parameters shown up to now by implementing a so-called reset. The control object 96 stands for closing down the statistics 70 shown here. The control object 98 stands for selecting a user. Control object 100 can also be used to call up help. The control object 102 is used for storing operating parameters. A control object 104 is used to compare different treatment stations and/or vessels and consequently bottles. It is possible to give or trigger an alarm using the control object 106. Statistics in the form of bar charts can be shown by using the control object 108 and statistics in the form of a diagram by using the control object 110.

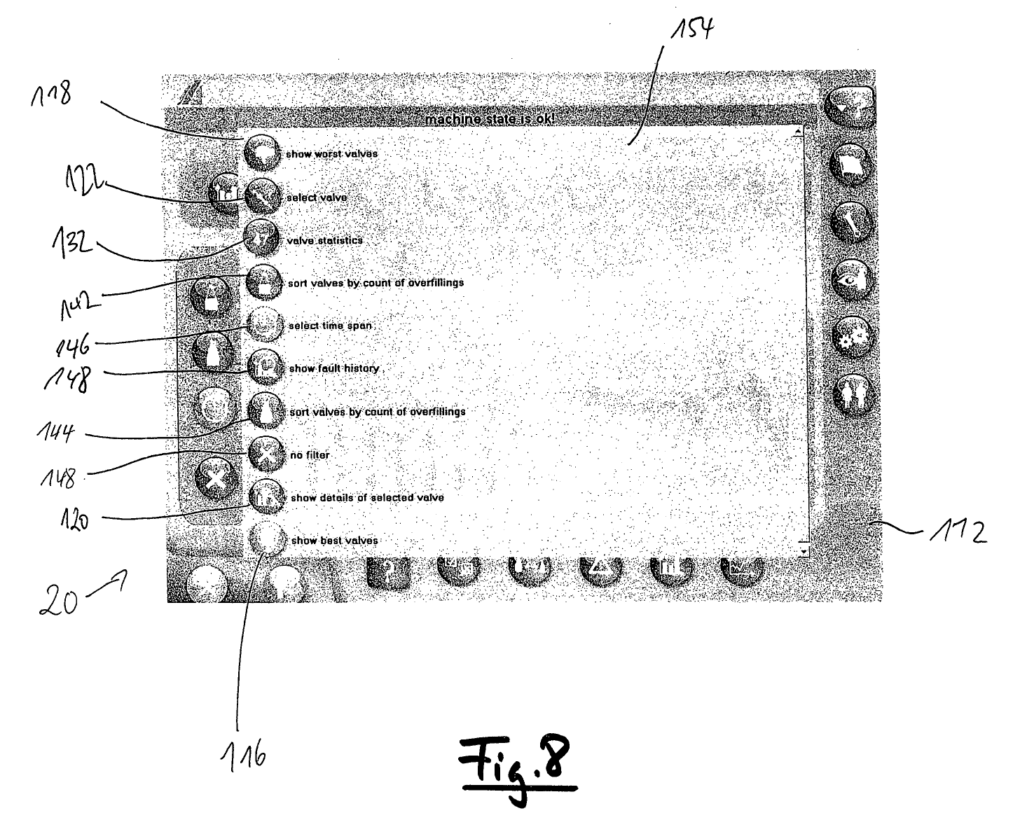

Detail statistics 112 of the tree structure 20 are shown schematically in FIG. 7. Various control objects are shown here too. In this case, a control object 114 stands for statistics in the form of bar charts, using a control object 116 on which a trophy can be seen, a best treatment station and consequently a best valve of the installation can be selected, a control object 118 is used for selecting a worst treatment station and consequently a worst valve. A control object 120 stands for a detailed representation of a treatment station. A control object 122 represents a selection of a treatment station. Using a control object 124, a time-dependent representation of the statistics in the form of bar charts can be selected and using a control object 126 help can be requested.

Below the seven control objects 114, 116, 118, 120, 122, 124 and 126, which are represented in a first row of the detail statistics, there is a second row of control objects, which has on the left a first selection button 128 to select an operating parameter and on the right a second selection button 130, which is also realized for selecting an operating parameter. The numerals “24”, “13”, “8”, “49” and “47” are shown on the other control objects 132, 134, 136, 138, 140. These aforementioned numerals stand for different treatment stations for which statistics can be selected and displayed by means of said control objects 132, 134, 136, 138, 140 such that operational reliability of said treatment stations can be checked.

In addition, the detail statistics include a filter with four control objects 142, 144, 146 and 148 arranged one above the other. The first object 142 shows a bottle insufficiently filled by a treatment station, a second control object 144 shows a bottle over-filled by a treatment station, a third control object 146 shows a clock to display a time and a fourth control object 148 shows a cross for calling up the representation of the detail statistics 112.

A first display field 150 within the detail statistics shows a bar chart to represent insufficiently filled vessels (black) and over-filled vessels (light) as a function of the time. A second display field 152 shows a diagram regarding an operating parameter of the installation also as a function of the time.

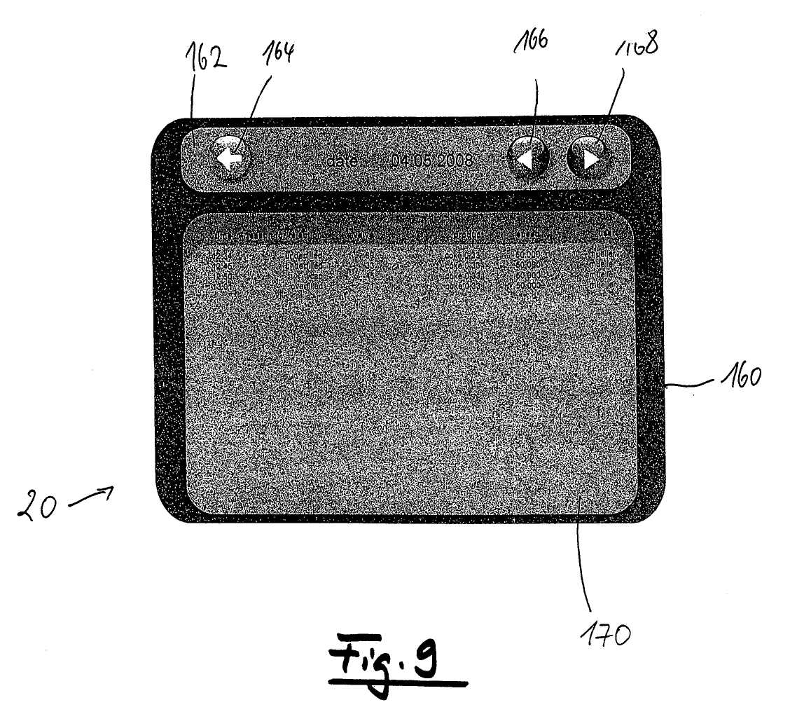

FIG. 8 also shows the detail statistics 112 from FIG. 7, now superimposed by an additional field 154, explanations on the control objects already presented by way of FIG. 7 being represented in said additional field. In this case, the control object 118, with the hand with the thumb pointing downward, stands for a worst treatment station and consequently for a worst valve of the installation (“show worst valves”). The control object 122 stands for a selection of a treatment station to be checked for operational reliability, in this case for a valve selection (“select valves”). The control object 132 with the numeral “47” stands for “valve statistics” and consequently for statistics of the treatment station. The control object 142 stands for sorting valves according to a number of over-fillings by non-operationally reliable treatment stations. The control object 146 stands for a selection of a time span (“select time span”). The control object 148 stands for fault statistics (“show fault history”). The control object 144 also stands for sorting the treatment stations and consequently valves according to a number of over-fillings. The control object 148 stands for switching off a filter. The control object 120 stands for representing details of a selected treatment station, for example of a selected valve, and the control object 116 stands for representing a best treatment station, for example a best valve.

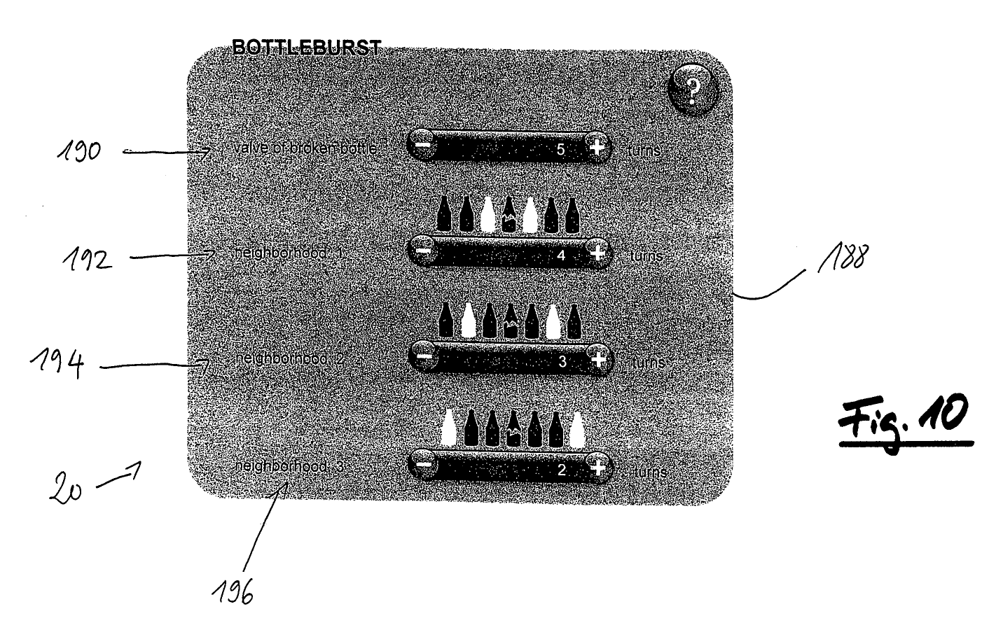

FIG. 9 is a schematic representation of a fault history 160, as is shown within the framework of the tree structure 20. In this case, said fault history 160 includes in a first display field 162 three control objects 164, 166, 168 that feature arrows, and via which it is possible to jump between different levels within the tree structure 20. In addition, a current date, in this case May 4, 2008, is displayed in this display field 162. The fault history 160 is shown as a table in a second display field 170. In this case, a first column shows the times (“time”), a second column gives the reasons for rejection (“reasons for rejection”), a third column gives a number of a treatment station, in this case of a valve (“valve”), a fourth column provides identification of a product (“product”), a fifth column shows a speed (“speed”) and a sixth column gives a name of a respective user (“user”).

Four incidents are displayed in the fault history 160. In this case, there was a first incident at 12:34 caused by insufficient filling at one treatment station—with valve “89”, there was another insufficient filling (“underfilled”) at 12:45 at a treatment station—with valve “33” and in a third incident at 12:50 there was a faulty closure (“cap”) at 12:50 at a treatment station—with valve “45”. In addition, at 13:01 there was overfilling (“overfilled”) at one treatment station—with valve “71”. All four incidents occurred during the filling of cola into 0.33 I vessels (“coke 0.33 I) at a speed of 50,000 units under the supervision of the user Muller (“mueller”).

The fault history 160 shown here enables a sequence, for example a process for filling containers with corresponding bulk goods—for example liquid product—in treatment stations of the installation that are to be correspondingly monitored, to be interrogated in a defined manner. In this case, among other things, an optimum speed for a respective product can also be determined. It is additionally possible using the fault history 160 to perform, per product and speed, an offset correction of a fill volume for a vessel for individual treatment stations and consequently valves. This includes the measures—increasing a frequency for processing vessels through treatment stations, if at least one treatment station has been defined as an error location and has been excluded from the ongoing operation of the installation. A lack of treatment stations can be compensated for by increasing the frequency. In addition, individual treatment stations or valves provided for filling the vessels can be excluded or barred by means of control objects 164, 166, 168. In addition, it is possible to suppress and consequently prevent a faulty vessel or a faulty bottle being closed by a treatment station excluded from the operation.

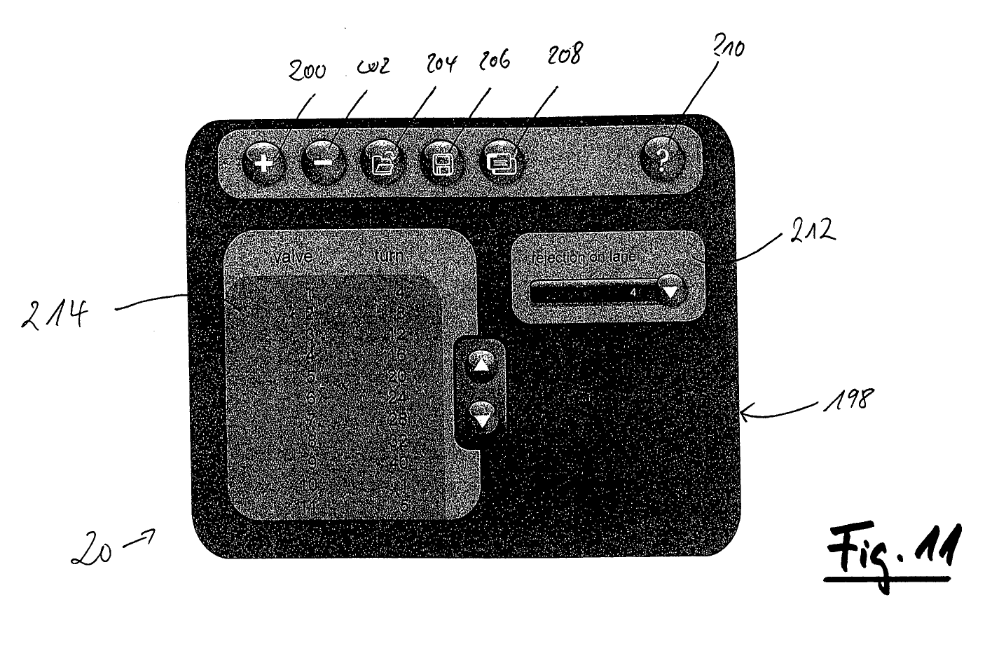

FIG. 10 shows a schematic representation of another level 188 of the tree structure 20, via which bottle breakage (“bottleburst”) caused by a faulty treatment station is documented. This level 188 includes a first display field 190, which indicates at which treatment station or at which valve the breakage occurred; in the example shown here this is the fifth valve. A second display field 192 is used to represent a first vicinity, and consequently bottles directly adjacent the broken bottle. A third display field 194 is used to represent a second vicinity of the broken bottle, i.e. of bottles that are spaced one bottle away from the broken bottles, and a fourth display field 196 represents a third vicinity of the broken bottle and accordingly of bottles that are spaced two bottles away from the broken bottle.

Using this level 188 shown in FIG. 10, the tree structure can be set to show how long the non-operationally reliable treatment station, and consequently a valve that was the cause of the break in the bottle and its neighbouring valves, remain unused. Consequently, it is possible to switch off the non-operationally reliable treatment stations or the respective valve, or to block a bottle being transferred to the corresponding treatment station. In addition, it is possible to carry out a statistical analysis of the bottle breakage with regard to different operating parameters of the installation, for example the position, the speed, the treatment station or the filled product.

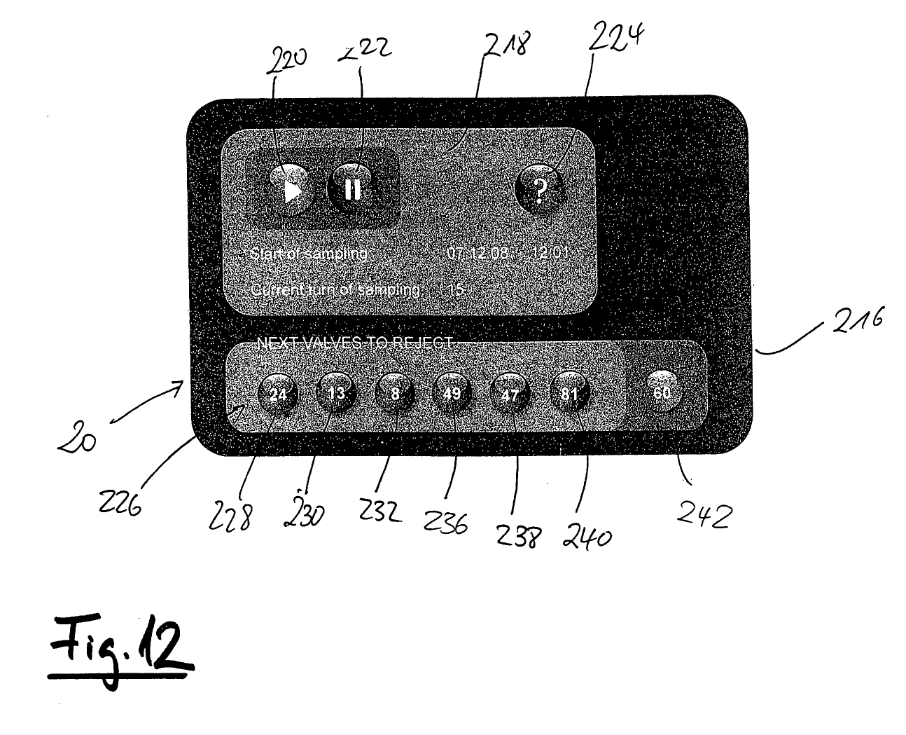

FIG. 11 is a schematic representation of a summary 198 as a further level of the tree structure 20. In this case, this summary 198 also includes a plurality of control objects 200, 202, 204, 206, 208 and 210. Using the control objects 200, 202, on which are the symbols “+” and “−”, zooming into and out of the representation is possible. In addition, control object 204 is used to open a folder, control object 206 to store a file and control object 208 to manage a file. A first display field 212 indicates at which treatment station, realized as a production lane, a rejection occurred when the vessels were being filled by valves (“rejection on lane 4”). A second display field 214 shows in a first column of a representation in the form of a table, a number of treatment stations, in this case valves, from 1 to 11 and an associated number of cycles or treatment cycles (‘turn”) in each case during which a respective valve is checked for its operational reliability.

Using the tabular list represented in the second display field 214, each user can assemble and store their own “sampling list” or summary list. In this case, a development of the method can provide that defaults exist for different filler types in an installation.

FIG. 12 shows a schematic representation of a sampling mode 216 as another level of the tree structure 20. In this case, a first display field 218 includes a start button 220 and a pause button 222 and another control object 224 for providing help. Using the start button 220, a check on treatment stations can be started. With pause button 222, it is possible at any time to interrupt the check by depressing the button. In addition, parameters concerning the start of the summary (‘start of sampling”, 07.12.08 at 12:01 hours) and information concerning a current run through the summary, in this case “15”, are shown in the display field 218. A plurality of control objects 228, 230, 232, 234, 238, 240 and 242 are shown in a second display field 226. The last-mentioned control objects 228, 230, 232, 234, 238, 240, 242 stand for treatment stations of the installation that include different valves, a respective number of a respective treatment station and accordingly of a respective valve being displayed on each of said control objects 228, 230, 232, 234, 238, 240, 242. By operating or activating the control objects 228, 230, 232, 234, 238, 240, 242 it is possible to exclude a respective treatment station comprising a valve from the production (“next valves to reject”) if said valves have been defined as error locations. This summary mode 216, as is shown as an example in FIG. 12, gives the user of the installation the possibility of activating “sampling” and monitoring vessels.

1. A method for monitoring an installation configured for the automatic handling of vessels for accommodating bulk goods and having a number of treatment stations for the vessels, said method comprising:
for each vessel, providing a precise allocation to processing stations that act upon the vessel,
checking treatment stations for operational reliability during the ongoing operation of the installation, and
defining treatment stations identified as non-operationally reliable for the ongoing operation as error locations to be automatically excluded from further operation,
wherein checking treatment stations for operational reliability comprises,
after the filling process, determining a fill level of the bulk goods for at least one vessel to be filled at a treatment station to be checked during the ongoing operation, and
performing a check as to whether the fill level is within or outside a tolerance range for the fill level, and
wherein, if the fill level is outside the tolerance range for the fill level, the at least one vessel is separated out, and the corresponding treatment station is defined as an error location and automatically excluded from the further operation of the installation.

2. The method of claim 1, wherein, during ongoing operation, the treatment stations are configured to carry out at least one operation selected from the group consisting of cleaning, filling, covering and labelling the vessels.

3. The method of claim 1, wherein said treatment stations are configured as filling stations with valves for bulk goods to be filled into the vessels.

4. The method of claim 1, further comprising automatically deactivating a treatment station defined as an error location.

5. The method of claim 1, further comprising, during ongoing operation, preventing all vessels from being supplied for treatment to a treatment station that has been defined as an error location.

6. The method of claim 1, further comprising preparing a status report on a treatment station that has been defined as an error location, and servicing said treatment station at a definable moment.

7. The method of claim 1, further comprising, based at least in part on the type and number of treatment stations defined as error locations, modifying at least one operating parameter of the installation during ongoing operation.

8. The method of claim 7, wherein modifying at least one operating parameter comprises modifying a frequency for treating the vessels.

9. The method of claim 1, further comprising randomly checking treatment stations for operational reliability.

10. The method of claim 1, further comprising:
during ongoing operation of the installation, cyclically repeating a sequence of treatment steps carried out by corresponding treatment stations in treatment cycles;
storing a sequence plan that includes predetermined information on which of the treatment stations are to be checked for operational reliability in which treatment cycle, said sequence plan being available to be called up during ongoing operation; and
calling up said sequence plan during ongoing operation.

11. An arrangement for monitoring an installation, the installation being configured for the automatic handling of vessels for accommodating bulk goods, and having a number of treatment stations for the vessels,
whereby there is provided, for each vessel, a precise allocation to treatment stations that act upon the vessel, to enable checking of treatment stations during ongoing operation of the installation for operational reliability,
defining treatment stations identified as being non-operationally reliable for ongoing operation as error locations, and
automatically excluding treatment stations identified as being non-operationally reliable from any further operation,
wherein, when checking the operational reliability of the treatment stations, the arrangement is configured to determine, after the filling process, a fill level of the bulk goods for at least one vessel to be filled during ongoing operation at a treatment station to be checked,
to check whether the fill level is within or outside a tolerance range for the fill level, and
if the fill level is outside the tolerance range, to define the treatment station as an error location and to exclude the treatment station automatically from further operation of the installation.

12. An arrangement according to claim 11, said arrangement, being configured to execute a method that includes the following steps:
for each vessel, providing a precise allocation to processing stations that act upon the vessel,
checking treatment stations for operational reliability during the ongoing operation of the installation, and
defining treatment stations identified as non-operationally reliable for the ongoing operation as being error locations to be automatically excluded from further operation,
wherein checking treatment stations for operational reliability comprises.,
after the filling process, determining a fill level of the bulk goods for at least one vessel to be filled at a treatment station to be checked during the ongoing operation, and
performing a check as to whether the fill level is within or outside a tolerance range for the fill level, and
wherein, if the fill level is outside the tolerance range for the fill level, the at least one vessel is separated out, and the corresponding treatment station is defined as an error location and is automatically excluded from the further operation of the installation.

13. An arrangement according to claim 11, said arrangement having at least one sensor that is associated with at least one treatment station, said at least one sensor being configured to detect a state or operating parameter of the respective treatment station and/or a state of a vessel to be treated at the treatment station.

14. An installation for the automatic handling of vessels at treatment stations, said installation comprising:
a monitoring arrangement for monitoring said installation, the monitoring arrangement being configured for determining, after the filling process, a fill level of bulk goods for at least one vessel to be filled during ongoing operation at a treatment station to be checked,
checking whether the fill level is within or outside a tolerance range for the fill level, and
if the fill level is outside the tolerance range, defining the treatment station as an error location and automatically excluding the treatment station from further operation of the installation.

15. An installation according to claim 14, wherein said installation is configured for automatic handling of bottles.

16. An installation according to claim 14, said installation being configured to monitor a respective state of the vessels.

17. An installation according to claim 14, wherein said installation comprises, as at least one of the treatment stations, a conveying device for conveying the vessels.

18. An installation according to claim 14, said installation having at least one filling device for filling vessels with bulk goods.

19. The method of claim 6, further comprising selecting said definable moment to be when operation of the installation has been completed.

20. The method of claim 8, wherein modifying said frequency comprises increasing said frequency.
